(19) United States
(12) Patent Application Publication
(10) Pub. No.: US 2004/0054768 A1
(43) Pub. Date: Mar. 18, 2004

(54) Logical access server comprising access cards which enable service providers to supervise communication operators equipment

(76) Inventors: Pekka Valipirtti, Oulu (FI); Heimo Pentikainen, Oulu (FI); Jouko Hallikainen, Oulu (FI); Janne Kuvaja, Jaali (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/415,135

(22) PCT Filed: Oct. 19, 2001
(86) PCT No.: PCT/FI01/00910

(30) Foreign Application Priority Data
Oct. 25, 2000 (FI) 20002346

(51) Int. Cl. G06F 15/173

(52) U.S. Cl. 709/223

(57) ABSTRACT

The invention concerns three kinds of telecommunication equipment: access cards, logical access servers consisting of said access cards, and the network management system (NMS) for supervising the logical access servers. The first item of telecommunication equipment according to the present invention, the access card, is similar to a PCU card. It also includes RAM memory and at least one processor. The access card is equipped with 1) a fixed Internet address, 2) an access agent, 3) at least one management information base (MIB), and optionally 4) a supervisory agent The MIB is a virtual information base, which is used to specify data pieces in data requests. An Internet service provider's application communicates with the access agent and requests the data stored in the access card by means of the MIB. The supervisory agent controls logins to the access card and the use of the access card. The second item of telecommunication equipment according to the present invention is the logical access server. Each Internet service provider (ISP) has its own logical access server, which consists of access cards. These access cards may belong to one or more telecommunication servers of an operator. The third item of telecommunication equipment according to the present invention is an NMS for supervising the logical access servers. The NMS enables: the naming of logical access servers, the addition and removal of access cards to logical access servers, and the supervision of logical access servers.

### FIELD OF THE INVENTION

The present invention relates generally to network management and the utilization of information stored in an access server.

### BACKGROUND OF THE INVENTION

“Operation and maintenance” is the conventional term for the control and supervision of telecommunications networks. One of the most important activities in the operation of a network is subscriber management. The operator should be able to add a new subscriber record to its network and provide the services demanded. The operator should also be able to change and remove subscriber records from the network. Another important activity is the collection of charging information. This information is collected several times during twenty-four hours. The billing of subscribers is based on the charging information.

The purpose of maintenance is to prevent faults and disturbances and to correct any faults which may arise. Faults and disturbances are reported by means of alarms. Preventive maintenance comprises measurements and supervision. A measurement may indicate, for example, a risk of overload in the network. Supervision is based on measurements and certain lower or upper limits applied to the results measured.

For example, if an overload limit of a switching center has been reached, the switching center generates an alarm report and sends the alarm report to the supervising unit, which then informs operator's staff. Then the operator's staff may execute actions to cut down the load of the overloaded switching center. Alternatively, the supervision may reduce the load automatically. This is termed “corrective maintenance”. Corrective maintenance comprises automated actions for correcting the existing faults.

The network management concept covers the operation and maintenance activities mentioned, as well as many other advanced activities for controlling and supervising a network. A network management system (NMS) is a software product for network management. In the present application, an access server is any equipment in an operator's network, wherein the access server includes information of interest to the other party. The other party may be a person or a service provider, for example, an Internet service provider (ISP). Typically, an ISP provides Internet services to its own customers by utilizing one or more operators' networks. In the present application, the ISP term is used to refer to the other party.

Traditionally operators' networks have been closed systems, which only the operators' staff has been allowed to manage. Now that use of the Internet has increased and new ISPs have come on the markets, the need has arisen to open these closed systems. For this reason also ISP staff has been allowed to execute some actions in the operators' network.

For example, an ISP may be allowed to utilize PCU cards (Packet Control Unit cards) located in the operators' access servers.

The PCU cards are used to convert the data received from the PSTN or ISDN network into a form which enables the sending of data to the IP network. Each PCU card includes at least one processor and RAM memory. A special processor, which is termed Digital Signal Processor (DSP), can be plugged into the PCU card. One access server usually includes several PCU cards.

An agent enables the utilization of data stored in the RAM memories of PCU cards. This data might be, for example, subscriber data or charging data. The agent is an application, and it communicates with customer applications, which are not located within oprators' network. The agent and the customer applications locating outside of the access server may communicate using simple network management protocol (SNMP).

The term “management information base” (MIB) is a concept defined by the Internet engineering task force (IETF). A MIB is a virtual information base which consists of objects defined according to abstract syntax notation one (ASN. 1).

Each object stored in an MIB has a name, a syntax, and an encoding rule. The name is an object identifier, an administratively assigned name which specifies an object type.

Each MIB defines a certain hierarchy for how data is stored. The purpose for its use determines what kind of hierarchy is the most practical for certain data. For example, when the data relates to network management, one practical MIB includes these hierarchical levels: country, city, switching center, access server, and PCU card.

In this case, the notation 4.1.3.2.5 refers to “country 4”, “city 1”, “switching center 3”, “access server 2”, and “PCU card 5”.

Some MIBs are vendor specific (vendor MIBs), and some MIBs are called entity MIBs because they define the hierarchy of an entity. For example, a switching center may be this kind of entity. There are many different ways to build up an MIB. However, the agent and the customer applications must have the same MIB in order to enable cooperation.

By using the MIB, a customer application can disclose which piece of data it needs. Then an agent fetches the data needed from a PCU card by using the MIB and sends the data to the customer application. In prior art, there is one agent per access server and one virtual information base, such as an MIB, per access server.

FIG. 1 shows an example of a structure for a telecommunication server. A telecommunication server, such as a switching center, may consist of racks. Each rack may be equipped with shelves on which cartridges are laid, and each cartridge may include one or more plug-in units 1-8. These plug-in units may be PCU cards.

In FIG. 2, a cartridge including PCU cards operates as an access server. Terms such as: rack, shelf, cartridge, and plug-in unit may vary depending on the vendor of a telecommunication server. However, prior art access servers are more or less physical equipments: Sometimes two or more ISPs share an access server.

There are two drawbacks relating to the implementation of prior art access servers and their PCU cards.

One drawback is that an access server is relatively ineffective because it includes only one agent which must serve requests related to many PCU cards. Typically, these requests are sent by the network management system of an ISP. The access server is also vulnerable, since no data item stored in the PCU cards is available if the agent is collapsed.

The other drawback is that one existing agent can use only one or a few virtual information bases i.e. MIBs. However, different ISPs may prefer different MIBs, and some ISPs may prefer one MIB in a certain case and another MIB in another case. Therefore a desirable implementation of the PCU card would be that the data is available using a variety of MIBs so that each ISP may choose the MIB it prefers.

### SUMMARY OF THE INVENTION

The first objective of the invention is to speed up an access server so that it can serve several customer applications at the same time. In addition, it is less vulnerable than prior art access servers.

The second objective of the invention is to make an access server more adaptable so that information stored in the access cards is available using different virtual information bases.

The third objective of the invention is to design an access server which is less hardware dependent than prior art access servers. It should be possible to allocate any PCU card to any single ISP or many ISPs.

The fourth objective of the invention is to design a suitable supervision method for the access servers mentioned above. For example, the supervision method needs to allow each ISP to use the PCU cards and to obtain the services which have been promised to the ISP.

The first objective of the invention is achieved by using—new kind of data processing cards. These data processing cards are called access cards. Like PCU cards, access cards include a processor and a random access memory (RAM). In addition, an access card is equipped with 1) a fixed communication network address and 2) an access agent. The access agent and the customer applications may communicate using, for example, simple network management-protocol (SNMP).

Each access card is equipped with a fixed communication network address so that a user or an application can utilize the access card through the fixed communication address. For example, an application of an Internet service provider (an ISP) can communicate with the access agents located in the access cards through fixed Internet addresses of access cards. There are just as many access agents as there are access cards, which speeds up the access servers.

The second objective is achieved by using access cards, each of which is equipped with 1) a fixed communication network address, 2) an access agent, and 3) at least one virtual information base. By using a certain notation in reference to the virtual information base the customer application (e.g. ISPs application) can disclose which data item is needed. Then the access agent of the access card fetches the data item needed.

An access server consists of access cards, and each access card is equipped with at least one virtual information base. The virtual information bases of the access cards can differ. A prior art access server is typically equipped with only one virtual information base.

The third objective is achieved by using the access cards. The new kind of access server, called “logical access server”, consists of the access cards, which are accessible through the communication network though they may belong to different cartridges or switching centers. Each ISP has its own logical access server.

The fourth objective is achieved by designing a network management system (NMS) for the logical access servers. The new NMS enables the following operations. First, an operator can name logical access servers using, for example, the names of ISPs. Secondly, an operator can add an access card to a logical access server of an operator, and an operator can remove an access card from a logical access server. Thirdly, by the new NMS an operator can supervise that each ISP obtains the services promised to it.

In addition, the new NMS enables an operator to provide an NMS view to the logical access server of each ISP. Then the ISP may supervise its own subscribers by utilizing the NMS view.

The network management system can also include agents termed “supervisory agents”. Supervisory agents are placed on the access cards so that each access card is equipped with one supervisory agent of its own. The supervisory agent controls which customer applications or users are allowed to login to the access card. The customer applications or users which are allowed to login may communicate with the access agent of the access card and request some operation. The access agent has to get the permission of the supervisory agent before it can execute the operation requested. Thus, the supervisory agent also controls the access agent which is placed on the same access card with that supervisory agent.

### BRIEF DESCRIPTION OF THE DRAWINGS

The invention is described more closely with reference to the accompanying drawings, in which

FIG. 1 shows an example of a structure of a telecommunication server,

FIG. 2 depicts prior art access servers,

FIG. 3 shows how an ISP communicates with an access card,

FIG. 4 depicts logical access servers, and

FIG. 5 illustrates a network management system for supervising logical access servers.

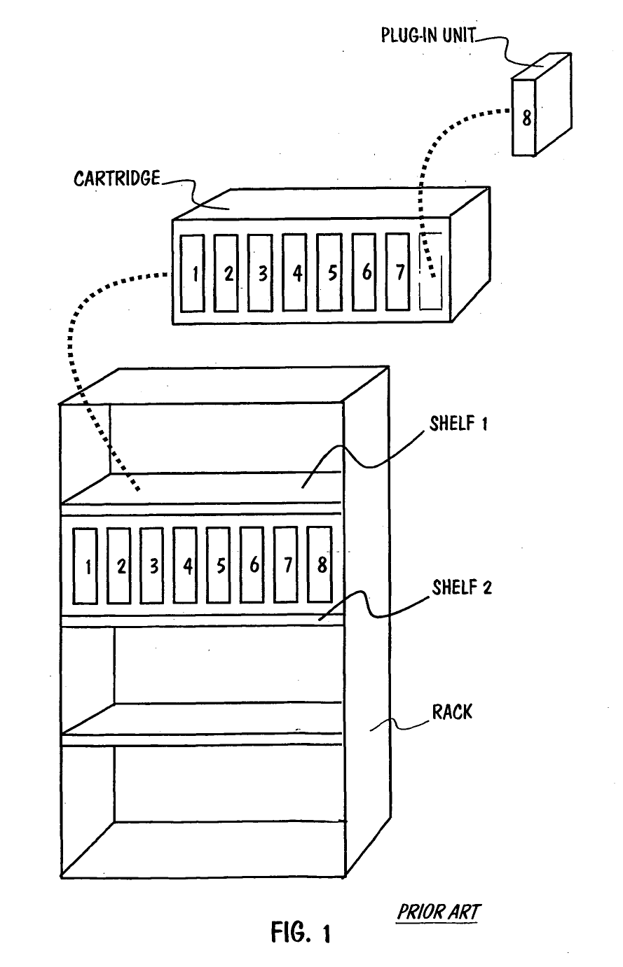

### DETAILED DESCRIPTION OF THE INVENTION

The present application concerns three kinds of telecommunication equipment:

access cards,

logical access servers consisting of said access cards, and

the NMS for supervising the logical access servers.

The first piece of telecommunication equipment according to the present invention is an access card, which is similar to a PCU card. It also includes a RAM memory and at least one processor, which may be a digital signal processor.

Each access card is equipped with 1) a fixed communication network address, 2) an access agent, 3) at least one MIB, and optionally 4) a supervisory agent. The Internet is nowadays a popular and highly utilized communication network. However, it might be replaced by some new communication network technologies in future. Therefore the fixed communication network address is not necessary a fixed Internet address.

As described in the background of the invention, “management information base” (MIB) is a concept defined by the Internet engineering task force (IETF). An MIB is a virtual information base consisting of objects defined in terms of abstract syntax notation one (ASN. 1).

After a successful login, the customer application may communicate directly with the access agent of the access card through the communication network. The communication may be based on simple service network protocol (SNMP).

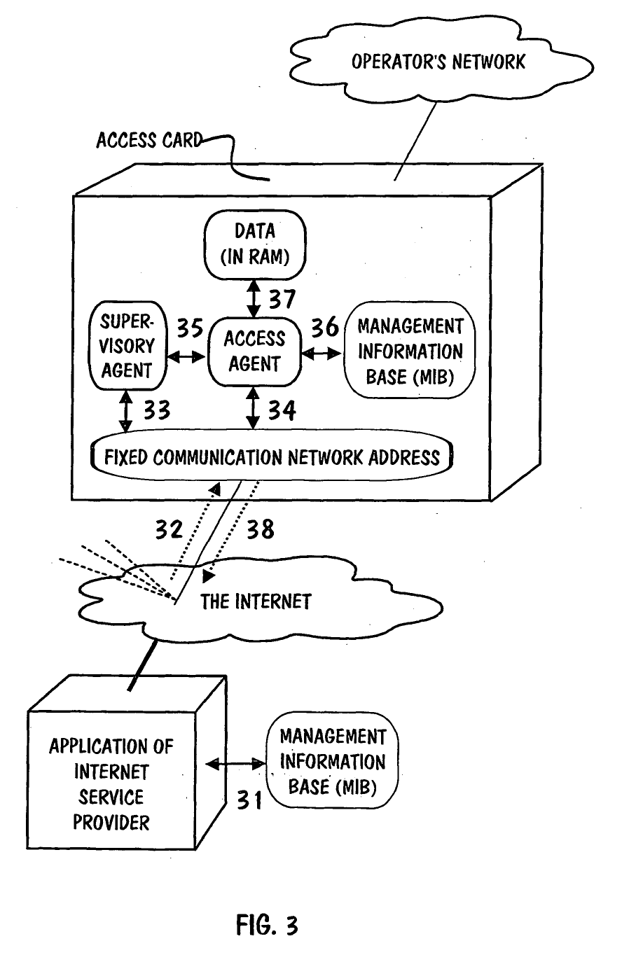

FIG. 3 shows a single access card and an ISP application communicating with it. The following describes typical usage of an access card:

An ISP application discloses by using the MIB what information it needs (31).

The ISP application tries to login to the access card (32).

The supervisory agent allows the login (33).

The ISP application communicates with the access agent and sends an operation request (34).

The access agent is notified by the supervisory agent that the operation request is permissible (35).

The access agent uses the same MIB as the ISP application to form a query (36).

The access agent executes the query and fetches the resulting information from the RAM (37).

The access agent sends the resulting information to the ISP application (38).

If required, the access agent and the supervisory agent can be replaced by one or more agents which execute their tasks.

In the above example, the operation request concerns fetching of data from the access card. However, the operation request may concern storing of data to the access card as well, or it may concern any updating operation or any operation of the NMS. The operation request received by an access card is initiated and sent by an application or a user, which has a certain permit or licence to use the access card.

The second piece of telecommunication equipment according to the present invention is the logical access server. As described above, each logical access server consists of access cards.

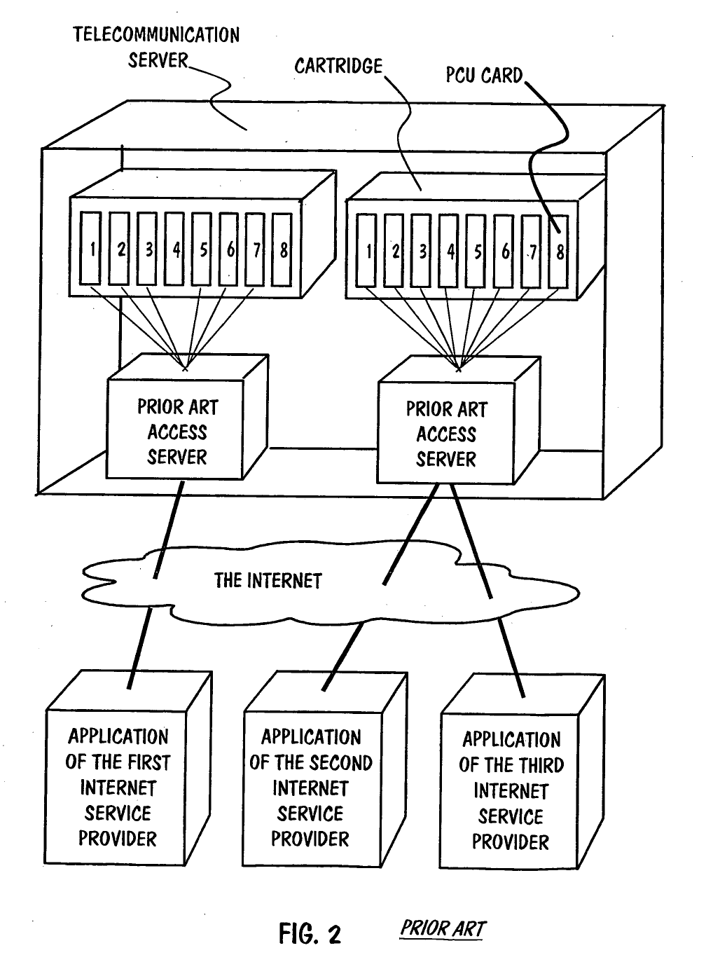

A telecommunication server equipped with logical access servers may be physically similar to the prior art telecommunication server shown in FIG. 2. It is also constructed of racks, shelves, cartridges, and plug-in units.

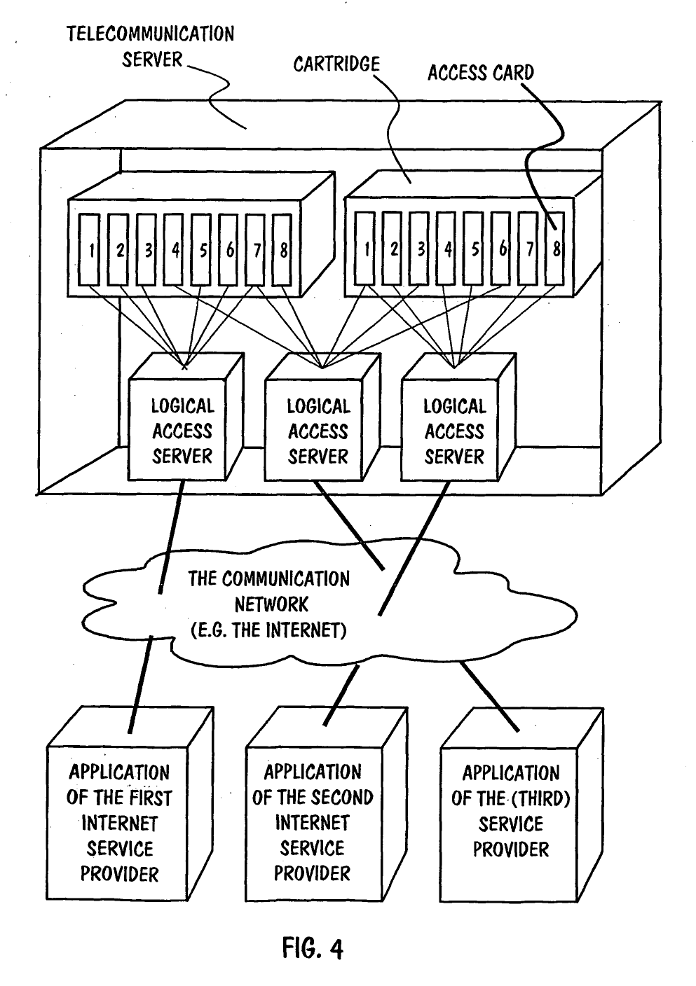

FIG. 4 shows an example of a telecommunication server equipped with logical access servers.

Three main characteristics separate the logical access server and a prior art access server.

First, the logical access server may consist of the access cards of many cartridges, which belong to one telecommunication server as shown in FIG. 4. However, the logical access server can be located in only one cartridge as well. Then the logical access server consists of the plug-in units of one cartridge just like a prior art access server. The logical access server may also consist of the access cards of many cartridges, which belong to different telecommunication servers.

Secondly, the access cards of a logical access server are connected to the communication network. Thus the use of the access cards is independent of the physical structures of the telecommunication servers and their hierarchical structures.

Thirdly, each ISP (or a service provider) has its own logical access server. When an ISP needs a new access card, it can be easily allocated to the logical access server of the ISP. This is possible because each access card is an independent plug-in unit which can be allocated freely to any ISP. ISPs may also share the same access card. When an access card is no longer needed by an ISP, it can be deallocated.

If an ISP needs a certain kind of access card and an operator has that access card located in one of its cartridge, it can be easily allocated to the ISP. In this case, the allocation of an access card is executed merely by using commands of the operator's network management system. The commands used may be MML (man machine language). In prior art, a PCU card must be physically located in a cartridge reserved for the use of a certain ISP before it can be allocated to that ISP.

The third piece of telecommunication equipment according to the present invention is the NMS for supervising the logical access servers. This NMS enables: 1) the naming of the logical access servers, 2) the addition and removal of access cards to logical access servers, and 3) supervision of logical access servers.

As described above, each logical access server consists of access cards, each of which is equipped with an access agent. The ISP application may communicate with the access agent by using simple network management protocol (SNMP). Therefore it is possible to offer a view to the logical access server of an ISP. Then the ISP may supervise itself by means of its own logical access server. A logical access server may consist of the access cards of several telecommunication servers. The data stored in the RAM of the access cards is transmitted through the fixed communication network addresses of the access cards. This saves a lot of message passing capacity for the operator's system compared to prior art access servers in which the data is transmitted by using the existing wiring of the operator.

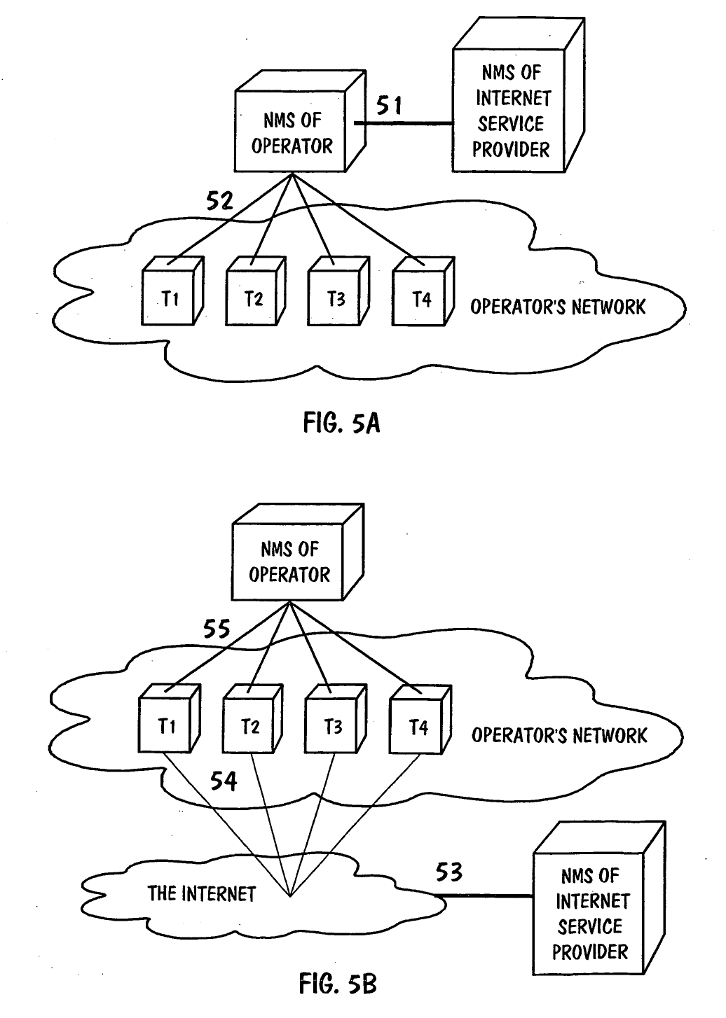

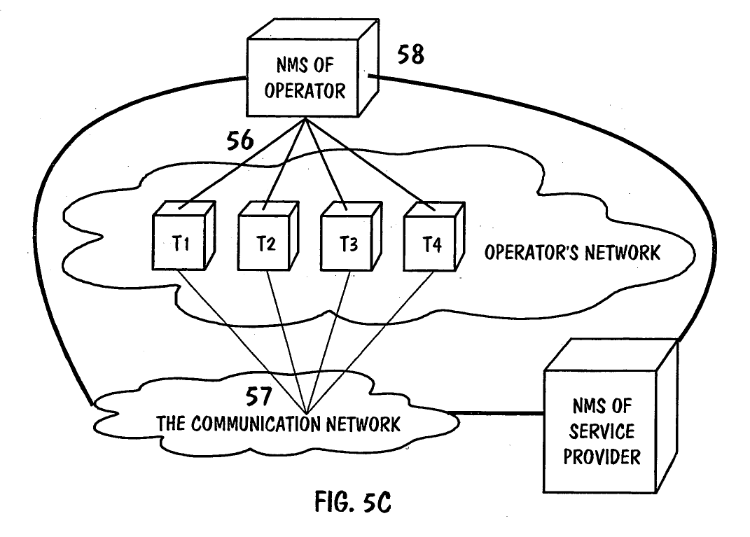

FIGS. 5a and 5b show two embodiments for how a view to the logical access server of an ISP can be offered. The telecommunication servers are marked T1-T4.

FIG. 5a shows the first embodiment, in which the NMS of the ISP communicates with the NMS of the operator and obtains a view to its logical access server through the NMS of the operator (51). The NMS of the operator is located at a certain geographical site, and the view is offered by using the existing wiring (52) between it and the telecommunication servers T1-T4. Because both the NMS of the operator and the NMS of the ISP use the existing wiring (52), the existing wiring might become a bottleneck of the system.

FIG. 5b shows the second embodiment, in which the NMS of the ISP communicates directly with the telecommunication servers via the Internet (53) by using a new wiring (54) which connects the access cards of the telecommunication servers to the Internet. In more detail, the NMS of the ISP communicates with its logical access server via the Internet through the fixed Internet addresses of the access cards which belong to its logical access server. In FIG. 5b, the exiting wiring (55) is used only by the NMS of the operator. Therefore a risk that the existing wiring will become a bottleneck of the system is essentially smaller in the second embodiment.

FIG. 5c shows a system, in which the Internet term is replaced by the communication network term and an ISP term is replaced by a service provider term. Of course, the same replacements can be associated with the first and second embodiments. In FIG. 5c, the NMS of the ISP may use the existing wiring (56) or the new wiring via the communication network (57). Correspondingly, the NMS of the service-provider may use the-new wiring via the communication network (57) or the existing wiring through the NMS of the operator (58).

The present invention also includes supervisory agents. Each supervisory agent controls the logins to its access card and the use of the access agent. In addition, the supervisory agent can be assigned the task of ensuring that the load of the access card does not exceed a certain overload limit. An access card, which is equipped with a supervisory agent, is a very independent unit. Even if the NMS of the operator would collapse, or the communication between the NMS of the operator and the access card is otherwise disturbed, the supervisory agent can still execute its tasks.

1. A method for using data stored in an access card, the access card comprising a memory and at least one processor and being a part of a communication server, wherein the access card is adapted for receiving and handling operation requests
characterized by the steps of:
equipping the access card with
at least one virtual information base with a certain notation for reading and updating contents of the memory,
a fixed communication network address, and
an access agent which is a program adapted to retrieve data from the memory and store data in the memory, and then
concerning the access card
controlling login attempts received through the fixed communication network address, and after a permitted login
receiving through the fixed communication network address an operation request related to the contents of the memory, wherein the operation request is disclosed by using said notation,
executing the operation request by using the access agent, and
sending the results of the operation request executed from the access card through the fixed communication network address.

2. A method as defined in claim 1, characterized in that at least one virtual information base is a management information base.

3. A method as defined in claim 1, characterized in that the operation request and the results are transmitted according to a simple network management protocol (SNMP).

4. A method as defined in claim 1, characterized in that the results include data which is retrieved from the memory.

5. A method as defined in claim 1, characterized in that the operation request includes data which is stored in the memory when the operation request is executed.

6. A method as defined in claim 1, characterized in that the access agent is further adapted to execute operation requests concerning the tasks of a network management system, the tasks comprising:
managing subscriber data and
forwarding charging information via the Internet through the fixed communication network address, wherein the charging information originates from the operator's telecommunication network,

7. A method as defined in claim 1, characterized by the further steps of:
equipping the access card with a supervisory agent, which is a program for executing the tasks of a network management system and
adapting the supervisory agent for
controlling the login attempts and accepting the permitted logins,
controlling the number of the login attempts so that the load of the access card remains under a certain overload limit,
reporting faults and disturbances by means of alarms, and
allowing the access agent to execute the operation request only when the requested operation is permissible.

8. An access card for a telecommunication server—, the access card comprising a memory and at least one processor, wherein the access card is adapted for receiving and handling operation requests,
characterized in that the access card comprises:
at least one virtual information base with a certain notation for retrieving and updating the contents of the memory, and
a fixed communication network address,
means for controlling login attempts received through the fixed communication network address,
means for receiving an operation request through the fixed communication network address, wherein the operation request includes notations in reference to the virtual information base of the access card,
an access agent for executing the operation request, wherein the access agent is a program adapted to retrieve data from the memory and store data in the memory, and
means for sending results of the executed operation request from the access card through the fixed communication network address.

9. An access card as defined in claim 8, characterized in that at least one virtual information base of the access card is a management information base.

10. An access card as defined in claim 8, characterized in that the operation request and the results are transmitted according to a simple network management protocol (SNMP).

11. An access card as defined in claim 8, characterized in that the results include data which is retrieved from the memory.

12. An access card as defined in claim 8, characterized in that the operation request includes data which is stored in the memory when executing the operation request.

13. An access card as defined in claim 8, characterized in that the access card comprises:
means for managing subscriber data and
means for forwarding charging information via the Internet through the fixed communication network address, wherein the charging information originates from the operator's telecommunication network,
wherein the access agent is adapted to execute the operation requests concerning tasks of a network management system.

14. An access card as defined claim 8, characterized in that the access card further comprises:
a supervisory agent, which is a program adapted to execute tasks of the network management system, the supervisory agent comprising
means for controlling the login attempts,
means for checking whether the operation requested is permissible before allowing the access, agent to execute the operation request,
means for controlling the number of logins so that the load of the access card does not exceed a certain overload limit, and
means for reporting faults and disturbances through alarms.

15. A logical access server locating at a network with telecommunication servers, logical access servers for utilizing the telecommunication servers, a network management system for supervising the logical access servers, and customers using the logical access servers,
characterized in that a logical access server consists of access cards, said access cards belonging to at least one telecommunication server, each access card having a memory and at least one processor and comprising:
at least one virtual information base with a certain notation for retrieving and updating the contents of the memory
a fixed communication network address,
means for controlling the login attempts received through the fixed communication network address,
means for receiving an operation request through the fixed communication network address, wherein the operation request is disclosed by using the virtual information base of the access card,
an access agent for executing the operation request, said access agent being a program adapted to retrieve data from the memory and store data in the memory, and
means for sending the results of the executed operation request from the access card from the fixed Internet address of the said access card.

16. A logical access server as defined in claim 15 characteri zed in that one access card is shared by several logical access servers.

17. A logical access server as defined in claim 15, character ized in that the access cards forming one logical access server belong to several telecommunication servers.

18. A logical access server as defined in claim 17, character ized in that the logical access server is adapted to receive and perform network management commands.

19. A logical access server as defined in claim 18, characteri zed in that the network management commands are man machine language commands (MML commands).

20. A logical access server as defined in claim 18, character ized in that the network management system comprises:
means for naming a logical access server, means for assigning the logical access server to one of the customers of the operator,
means for allocating the access cards to the logical access servers and deallocating the access cards from the logical access servers.

21. A logical access server as defined in claim 20, character ized in that the network management system further comprises:
means for supervising the logical access servers by using the supervisory agents placed on the access cards.

22. A logical access server as defined in claim 21, character ized in that the network management system is adapted to offer to a customer a view to logical access server assigned to the customer, and the customer supervises the logical access server by using the view.

23. A logical access server as defined in claim 22, character ized in that the view is offered so that the customer supervises the logical access server through the wiring of the telecommunication servers, which wiring connects each access card to one telecommunication server and each telecommunication server to the operator's telecommunication network.

24. A logical access server as defined in claim 22, character ized in that the view is offered so that the customer supervises the logical access server through fixed communication network addresses of access cards belonging to the logical access server.

25. A logical access server as defined in claim 22, character ized in that the fixed communication network address is a fixed internet address.
